(19) United States
(12) Patent Application Publication
(10) Pub. No.: US 2015/0347630 A1
(43) Pub. Date: Dec. 3, 2015

(54) METHOD, APPARATUS, AND SYSTEM FOR PROCESSING CALL REQUESTS

(71) Applicant: Alibaba Group Holding Limited, George Town (KY)

(72) Inventor: Lihong Li, Hangzhou (CN)

(21) Appl. No.: 14/721,334

(22) Filed: May 26, 2015

(30) Foreign Application Priority Data
May 29, 2014 (CN) 201410234381.X

(51) Int. Cl. G06F 17/30

(52) U.S. Cl. CPC G06F 17/30991

(57) ABSTRACT

Embodiments of the present application relate to a method, apparatus, and system for processing a call. The method includes receiving a query request from a terminal, wherein the query request includes the user identifier (ID) corresponding to the terminal, searching for order information, logistics information, or both corresponding to the user ID, in the event that order information, logistics information, or both corresponding to the user ID is found, generating a query response, wherein the query response includes the order information, logistics information, or both corresponding to the user ID, and sending the query response to the terminal.

### CROSS REFERENCE TO OTHER APPLICATIONS

This application claims priority to People's Republic of China Patent Application No. 201410234381.X entitled A METHOD AND A DEVICE FOR PROCESSING CALL REQUESTS, filed May 29, 2014 which is incorporated herein by reference for all purposes.

### FIELD OF THE INVENTION

The present application relates to a field of communications. In particular, the present application relates to a method, a device, and a system for processing call requests.

### BACKGROUND OF THE INVENTION

According to some related art, after a mobile phone terminal receives a call request, the mobile phone terminal can display the number of the caller. If the caller number and the name of the caller were previously saved in the contacts directory of the mobile telephone terminal of the called party, the caller number and name of the caller will be displayed on the incoming call display interface of the mobile phone terminal screen of the called party.

According to some related art, in the event that a mobile phone terminal receives a call request, the information relating to the call request that is displayed on the incoming call interface of the mobile phone terminal is extremely limited. In a user's everyday life, situations such as the following regularly occur: a courier or a repairman calls to provide notice of delivery or of repair service status. In regard to such situations, a user would perceive benefits if the user were to know information about the other party (the calling part). For example, the user could use such information about the other party in determining a next operating step (e.g., whether the user should accept the call, refuse the call, or the like).

In summary, currently after a mobile terminal receives a call request, very limited relevant information is displayed on the incoming call interface. Therefore, there is a need for a method, device, and system for providing more effective information in the event of an incoming communication to a device.

### BRIEF DESCRIPTION OF THE DRAWINGS

Various embodiments of the invention are disclosed in the following detailed description and the accompanying drawings.

FIG. 1 is a structural diagram of a system for processing call requests according to various embodiments of the present application.

FIG. 2 is a flowchart of a method for processing call requests according to various embodiments of the present application.

FIG. 3 is a flowchart of a method for processing call requests according to various embodiments of the present application.

FIG. 4 is a diagram of received information displayed on an incoming call display interface according to various embodiments of the present application.

FIG. 5 is a structural diagram of a network device according to various embodiments of the present application.

FIG. 6 is a structural diagram of a terminal according to various embodiments of the present application.

FIG. 7 is a functional diagram of a computer system for processing call requests according to various embodiments of the present application.

### DETAILED DESCRIPTION

The invention can be implemented in numerous ways, including as a process; an apparatus; a system; a composition of matter; a computer program product embodied on a computer readable storage medium; and/or a processor, such as a processor configured to execute instructions stored on and/or provided by a memory coupled to the processor. In this specification, these implementations, or any other form that the invention may take, may be referred to as techniques. In general, the order of the steps of disclosed processes may be altered within the scope of the invention. Unless stated otherwise, a component such as a processor or a memory described as being configured to perform a task may be implemented as a general component that is temporarily configured to perform the task at a given time or a specific component that is manufactured to perform the task. As used herein, the term ‘processor’ refers to one or more devices, circuits, and/or processing cores configured to process data, such as computer program instructions.

A detailed description of one or more embodiments of the invention is provided below along with accompanying figures that illustrate the principles of the invention. The invention is described in connection with such embodiments, but the invention is not limited to any embodiment. The scope of the invention is limited only by the claims and the invention encompasses numerous alternatives, modifications and equivalents. Numerous specific details are set forth in the following description in order to provide a thorough understanding of the invention. These details are provided for the purpose of example and the invention may be practiced according to the claims without some or all of these specific details. For the purpose of clarity, technical material that is known in the technical fields related to the invention has not been described in detail so that the invention is not unnecessarily obscured.

As used herein, a terminal generally refers to a device used (e.g., by a user) within a network system and used to communicate with one or more servers. According to various embodiments of the present disclosure, a terminal may include communication functionality. For example, a terminal may be a smart phone, a tablet computer, a mobile phone, a video phone, an e-book reader, a desktop Personal Computer (PC), a laptop PC, a netbook PC, a Personal Digital Assistant (PDA), a Portable Multimedia Player (PMP), an mp3 player, a mobile medical device, a camera, a wearable device (e.g., a Head-Mounted Device (HMD), electronic clothes, electronic braces, an electronic necklace, an electronic accessory, an electronic tattoo, or a smart watch), or the like.

According to some embodiments of the present disclosure, a terminal includes a smart home appliance with communication functionality. A smart home appliance can be, for example, a television, a Digital Video Disk (DVD) player, an audio device, a refrigerator, an air conditioner, a vacuum cleaner, an oven, a microwave oven, a washer, a dryer, an air purifier, a set-top box, a TV box (e.g., Samsung HomeSync™, Apple TV™, or Google TV™), a gaming console, an electronic dictionary, an electronic key, a camcorder, an electronic picture frame, or the like.

According to various embodiments of the present disclosure, a terminal can be any combination of the foregoing terminals. In addition, it will be apparent to one having ordinary skill in the art that a terminal according to various embodiments of the present disclosure is not limited to the foregoing terminal.

Various embodiments of the present disclosure include a method and a device (e.g., a terminal) for processing call requests. In some embodiments, in the event that a terminal receives a communication (e.g., a call request), the terminal acquires the user identifier (ID) of the terminal and sends to the network side (e.g., to a server) a query request which includes the user ID. The query request can query for more information relating to the user associated with the user ID. For example, the query request can query for order information associated with orders placed in connection with the user ID. In the event that the network side receives the query request from the terminal, the network side uses the user ID included in the query request to look up order information corresponding to the user ID and/or logistics information corresponding to the order information and sends the order information and/or logistics information via a query response to the terminal. The server can also search for other types of information in connection with the query request, such as transaction information, or the like, and include at least some of the found information in the query response. In response to receiving the query response, the terminal displays the received order information and/or logistics information on the incoming call display interface. For example, the terminal extracts information from the query response and displays the extracted information on the incoming call display interface. The terminal can display the extracted information concurrently with an indication of the incoming communication (e.g., the call request). After the terminal receives the call request, the terminal displays the received order information, logistics information associated with the user ID, and/or any other appropriate information on the incoming call display interface. Thus, in the event that the user receives the call request, the user is more informed of relevant information and is provided with more comprehensive reference information that the user can use in deciding a next operating step.

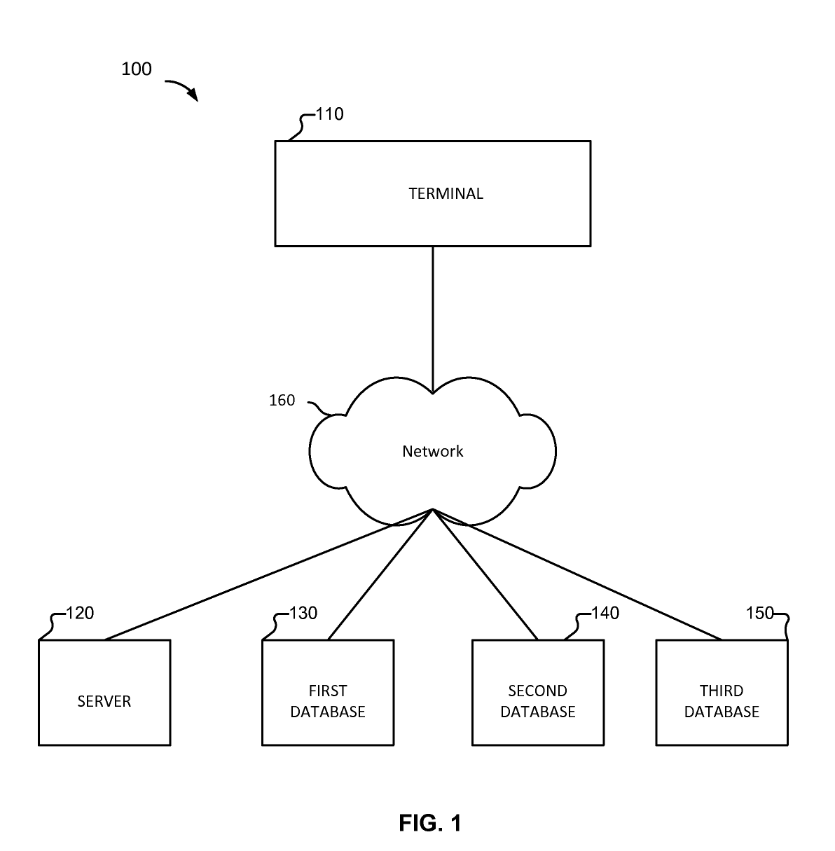

FIG. 1 is a structural diagram of a system for processing call requests according to various embodiments of the present application.

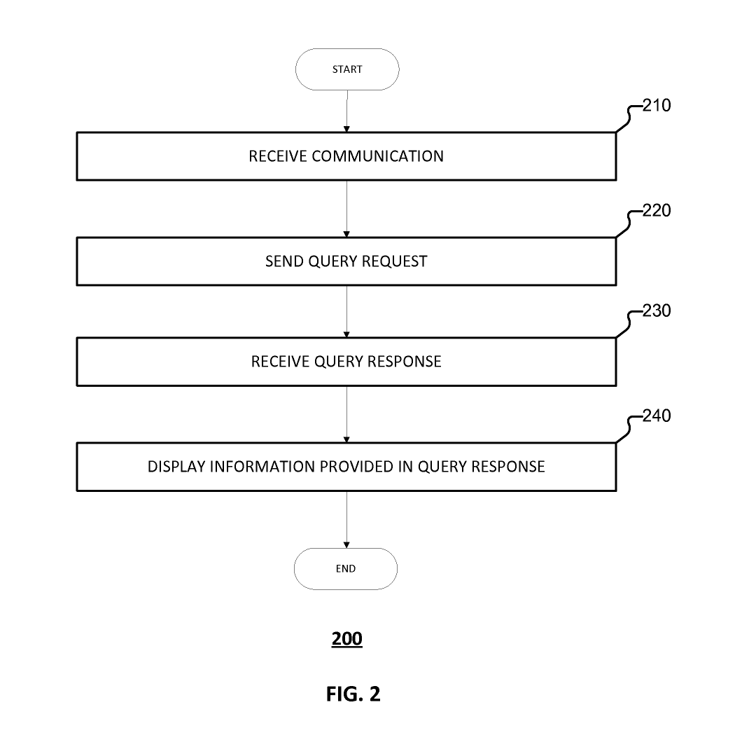

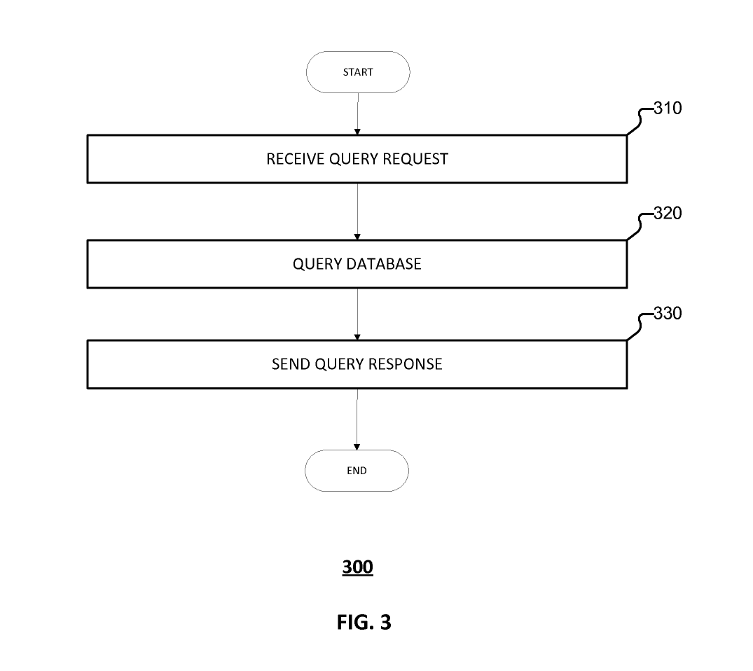

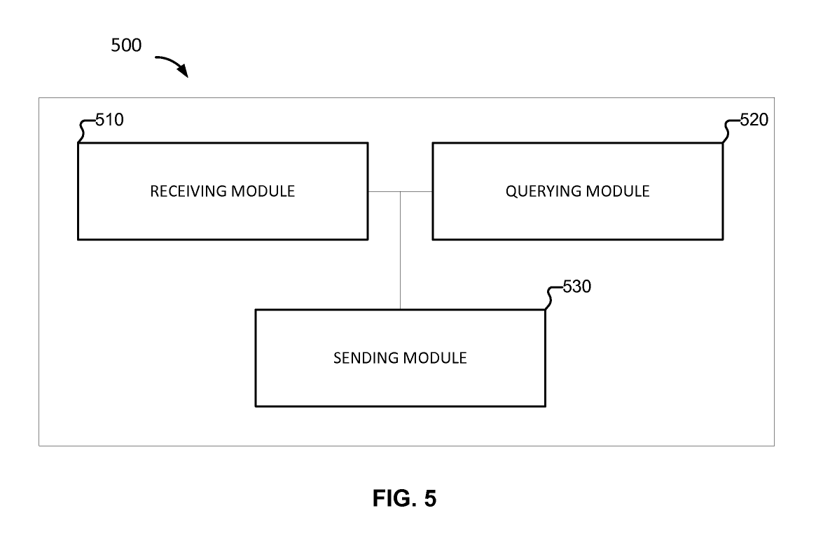

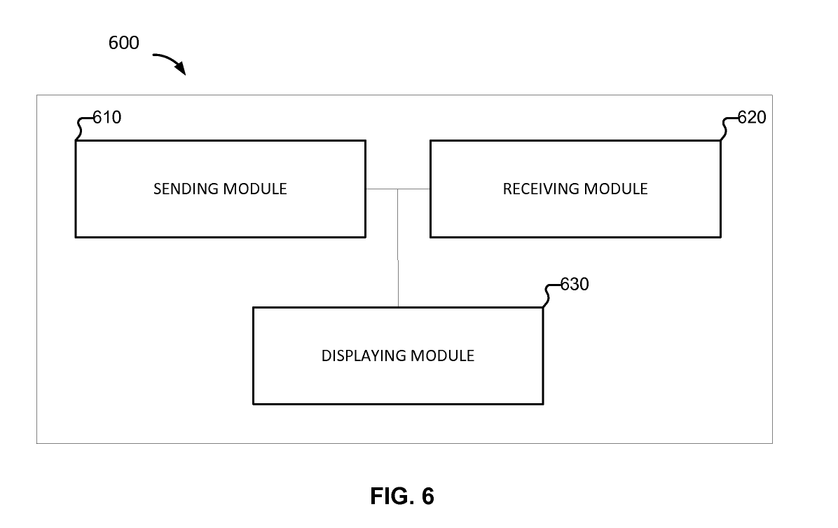

Referring to FIG. 1, a system 100 for processing call requests is provided. In some embodiments, the system 100 can implement a process 200 of FIG. 2 and/or a process 300 of FIG. 3. The system 100 can include network device 500 of FIG. 5 and/or a terminal 600 of FIG. 6.

The system 100 includes a terminal 110 and one or more network devices (e.g., a server 120). In some embodiments, system 100 includes a network 160 over which the terminal 110 and the server 120 communicate. In some embodiments, the terminal 110 logs into the server 120. For example, the server 120 hosts an application or an application system to which the terminal (e.g., a current user) logs in.

The terminal 110 can communicate a query request to the server 120. For example, in response to receiving a call request, the terminal 110 sends the query request to the server 120. The query request can include an identifier (e.g., a user ID) associated with a user of the terminal 110.

The system 100 can include a first database 130, a second database 140, or a third database 150. The first database 130, the second database 140, or the third database 150 can be connected to the server 120. Each database can be located on a separate device, or be co-located with one or more other databases on a device. The number of the databases and the type of information stored are for purposes of illustration only, and different numbers of databases storing different types of information can be used in other embodiments. As shown, the first database 130, the second database 140, or the third database 150 can be connected to the network 160. In response to receiving the query request from the terminal 110, the server 120 can query the first database 130, the second database 140, or the third database 150 in connection with responding to the query request. The server 120 can receive order information and/or logistics information from the first database 130, the second database 140, or the third database 150.

The server 120 can access one or more databases (e.g., the first database 130, the second database 140, or the third database 150). These databases store order information, logistics information, and the like. Furthermore, the server 120 can access a database belonging to a transaction system or a transaction platform (e.g., an order/payment processing system). The transaction platform can correspond to a third-party platform used to facilitate a transaction between two parties. The transaction platform provides a security platform that protects the security, integrity, or the like of the parties to a transaction. The first database 130 can store telephone numbers used to trigger related information queries. The telephone numbers are the telephone numbers of logistics personnel or telephone numbers of service providers. The first database 130 can store a relationship (e.g., a mapping) between a telephone number and a party (the logistics personnel, service provider, vendor, or the like registered with the telephone number). The second database 140 and the third database 150 can respectively belong to different transaction systems. For example, the second database 140 stores user IDs and order information corresponding to the user IDs, and the third database 150 stores user IDs and logistics information. Other mappings or database configurations can be used.

The terminal 110 sends a query request to the server 120 in response to receiving a call request. The terminal 110 sends the query request to the server 120 to request and acquire information relating to the currently received call request. In response to receiving the relevant information that is sent back from the server 120 (e.g., in the form of a query response), the terminal 110 displays the relevant information (e.g., order information, logistics information, or other transaction information) on the incoming call interface. The incoming call interface includes a graphical user interface which displays an indication of an incoming call, information associated with the incoming call, and with which a user can provide an input to answer the incoming call, to reject the incoming call, or the like. The input provided to the incoming call interface by the user can be a touch input to a touchscreen, a voice input, a button click, or the like. The incoming call interface can be a standard interface implemented on a phone for receiving a call.

In response to receiving a query request from the terminal 110, the server 120 executes a query operation. The server 120 can query a database (e.g., the first database 130, the second database 140, or the third database 150) in connection with the query operation. The query operation can include a query for information associated with a user ID included in the query request received from the terminal 110. In the event that the query operation is complete, the server 120 generates a query result and sends the query result to the terminal 110.

FIG. 2 is a flowchart of a method for processing call requests according to various embodiments of the present application.

Referring to FIG. 2, a process 200 to process call requests is provided. The process 200 can be implemented by the system 100 of FIG. 1, or terminal 600 of FIG. 6.

At 210, a communication is received. The terminal receives the communication over a communication network. In some embodiments, the communication received by the terminal corresponds to a call request (e.g., an incoming call). The call request can correspond to an incoming voice call. The call request can include information identifying the party from which the call originated (e.g., the caller). For example, the call request can include the number of the caller.

At 220, a query request is communicated. Specifically, in response to receiving the call request, the terminal sends the query request to query information relating to the call request to the server. For example, the query request can include a user ID. The user ID can identify the user associated with the terminal. The terminal can generate the query request based at least in part on the user ID of the user associated with the terminal. In some embodiments, the query request includes an identifier (e.g., a telephone number) that identifies the user associated with the call request (e.g., the party from which the call originated). In some embodiments, in the event that a phone application receives a call (e.g., the call request), the phone application sends a message to another application. The message sent by the phone application to the other application can include the call number (e.g., the telephone number of the calling party). In response to the other program receiving the message from the phone application, the other application can extract the call number or other information and search the data of the other application or a database for the call number. In some embodiments, the phone application broadcasts the message including the call number to the other application.

At 230, a query response is received. The terminal receives the query response from the server. The query response is sent back in response to the query request. In some embodiments, the server looks up in the databases the requested information, and includes in the query response order information corresponding to the user ID, logistics information, transaction information, other appropriate information, or any combination thereof. The query response can include an identifier that associates the query response with the corresponding query request. For example, the query response can include the user ID that is included in the query request.

At 240, information included in the query response is displayed. In response to receiving the query response, the terminal can extract information from the query response and display the information. For example, the terminal can extract and display the order information, logistics information, transaction information, or the like on an incoming call display interface. An application installed on the terminal can receive the query response and extract the information from the query response. The application can be an application that generates the query request and that communicates the query request to the server. The application can poll for reception of the query response. In the event that a query response is received from the server, the application can cause the terminal to display the incoming call display interface. For example, the application can launch the incoming call display interface. As another example, the application can invoke code that displays the incoming call display interface. The application can populate the incoming call display interface with the order information, logistics information, transaction information, or the like. The application can modify the native call answering functionality of a terminal. The application can display the order information, logistics information, transaction information, or the like on the incoming call display interface using an interface write using java or the like. For example, the interface write can include {int item id; num telephone number; int product name; product picture; order information id; logistics information id}.

In some embodiments, order information includes an order number, a picture of an ordered item, the name of the ordered item, the price of the ordered item, an order status of an order, a quantity of the ordered item, an expected delivery date of the ordered item, a name of the person that ordered the item, a date on which the item was ordered, an identifier (e.g., name) of a vendor or service provider, or other such order-related information.

In some embodiments, the logistics information includes a tracking number, the shipping company, the name of the delivery person, the point of origin, or other such logistics-related information.

In some embodiments, after receiving a call request, the terminal acquires the user ID corresponding to the terminal and includes the user ID in a query request which the terminal sends to the network side (e.g., the server). In some embodiments, the user ID is acquired by invoking an Application Programming Interface (API) call to the operating system. The server can be connected to, or otherwise provided access to, a transaction system that stores mappings to various user IDs. The transaction information can include product name, an image of the product, an order ID, a logistics ID, a courier's name, a courier's phone number, or the like. For example, the user ID included in the query request can be a user ID in a transaction system (e.g., the user ID can be registered with the transaction system). For example, in response to receiving the call request, the terminal locally acquires an e-commerce website user ID (e.g., the Taobao user ID) corresponding to the present terminal and generates a query request including the e-commerce website user ID (e.g., Taobao user ID). In the event that the terminal generates the query request, the terminal sends the query request with the user ID to the network side.

In some embodiments, in the event that a terminal is currently logged into a web-based or cloud service such as YunOS developed by Alibaba Group, and the user ID associated with the web-based or cloud service (e.g., the YunOS user ID) is associated with, or otherwise mapped to, an e-commerce website user ID (e.g., a Taobao user ID), the terminal can, in response to receiving a call request, use the user ID associated with the web-based or cloud service to which the terminal is currently logged into as a basis for acquiring the associated e-commerce website user ID (e.g., Taobao user ID). The terminal can include the e-commerce website user ID in the query request and send the query request to the network side (e.g., the server).

In some embodiments, the terminal searches for information associated with the calling number corresponding to the calling party of the call request in its local contacts database. In the event that the terminal is unable to find the calling number corresponding to the call request among the telephone numbers stored on the terminal, then the terminal sends a query request to the network side. The terminal (e.g., an application) can determine that the terminal is unable to find the calling number corresponding to the call request if the phonebook stored on the terminal does not include the calling number. For example, the terminal sends a query request that queries for information relating to an unknown incoming call. The query request includes the calling number corresponding to the call request (e.g., the calling number or other identifier corresponding to the calling party associated with the incoming call request). In response to receiving the query request including the calling number corresponding to the call request (of the unknown incoming call), the network device can determine whether acquiring information relating to the calling number is necessary. The network device can determine whether acquiring the information relating to the calling number is necessary by querying the first database according to the calling number included in the query request.

In some embodiments, in the event that the terminal searches for the calling number corresponding to the call request among the telephone numbers stored by the terminal, and the terminal confirms that acquiring information relating to the looked-up telephone number is possible (e.g., because the calling number is deemed to be associated with a specific service provider), the terminal sends a query request.

The terminal can store contacts in a local storage of the terminal. For example, the terminal can store a name, an address, personal information, or the like, associated with a user corresponding to a telephone number. In addition to saving a directory of regular contacts, the terminal can save a contacts database. The contracts database can be a database that is stored locally on the terminal. The contacts database stores the telephone numbers of logistics personnel, stores the telephone numbers of service providers, or the like. For example, the contacts database can store the telephone numbers of logistics personnel of multiple logistics companies. As another example, the contacts database can store the telephone numbers of service providers such as a food delivery service, an airline company, or a telecommunications provider.

In the event that the calling number corresponding to the call request received by the terminal is a telephone number stored in the contacts database, then the terminal determines to send a query request for the calling number. For example, in the event that the calling number corresponding to the call request received by the terminal is a telephone number stored in the contacts database, the terminal confirms that acquiring information relating to the looked-up telephone number can be performed because further information may be available with respect to the calling party. In response to receiving a call request, the terminal queries the contacts database to determine whether the contacts database has stored the calling number (e.g., whether the contacts database has a record corresponding to the calling number). If the contacts database has stored the calling number (e.g., if the contacts database has a record corresponding to the calling number), then the terminal sends a query request. The terminal can send the query request to the server according to whether the contacts database of the terminal includes the calling number.

The contacts database can be periodically updated. The contacts database can be updated according to a request issued to a web server by the terminal or automatically according to a push (e.g., at predefined intervals) of updated contact information from a web server. As an example, the terminal issues updating requests according to a set cycle to the systems (e.g., servers) at which the databases that store the contact information are located so as to request that contact telephone numbers be updated. As an example, the systems at which the databases that store the contact information are located can send at set times an update command to the terminal so as to cause the terminal to update the corresponding contact information.

The directory of regular contacts and the contacts database described can be integrated into one directory or database. The logistics personnel telephone numbers, service provider telephone numbers, or the like in the integrated directory can have specific marks (e.g., special bits or fields) associated therewith. If the terminal queries the integrated directory and finds a calling number that corresponds to the call request, and if the specific mark has been associated with (e.g., added to) the telephone number (or record) that was found, then the terminal sends a query request.

In a first implementation, the terminal, upon receiving an incoming call from a number deemed unknown because the number is not found locally, generates a query request that includes the number corresponding to the incoming call, and sends the query request to the network device. By querying the first database online, the network device determines whether there is a need to acquire related information. The first database may store large quantities of telephone numbers, service provider telephone numbers, the like, or any combination thereof. The data storage quantities can be considerable, and maintenance and updating of the first database are more convenient. In a second implementation, a terminal may locally store the telephone numbers of logistics personnel or service providers. In this case, when there is a call request, the terminal does not need to submit query requests via a network, and can determine whether or not a query request is required to be sent according to a result of a local query. The use of a local database and local queries of the local database reduces interaction between the terminal and the network side and thus reduces the consumption of network resources. In some embodiments, there are two types of query requests—a first query request for information relating to a caller, and a second query request for information relating to order information or logistic information. In some embodiments, the type of query request communicated can depend on the information stored locally (e.g., whether a local database or the like stores information corresponding to the caller associated with the call request).

The terminal can determine whether the calling number corresponding to the current call request is the telephone number of logistics personnel, a service provider, or the like. In the event that the calling number corresponding to the current call request is the telephone number of logistics personnel, a service provider, or the like, then the terminal sends a query request to request and acquire information relating to the calling number (e.g., order and/or logistics information) and displays the information relating to the calling number that the terminal receives in response to the query request.

FIG. 3 is a flowchart of a method for processing call requests according to various embodiments of the present application.

Referring to FIG. 3, a method 300 for processing a call by a server is provided. The process 300 can be implemented by system 100 of FIG. 1, or network device 500 of FIG. 5.

At 310, a query request is received. A server (or other network device) receives the query request from a terminal. The query request includes the user ID corresponding to the terminal. The query request is sent by the terminal in response to the terminal receiving a call request.

At 320, a database is queried. The server can query a database (or other form of storing information mapped to user IDs) based at least in part on information included in the query request. For example, the server can use the user ID included in the query request to look up order information corresponding to the user ID, logistics information corresponding to the order information, or the like.

At 330, a query response is sent. The server sends the query response to the terminal. For example, in the event that the database is queried, the server can generate the query response (with results of the query) and send the query response to the terminal. The server can send the order information, the logistics information, or the like, via a query response to the terminal so as to cause the terminal to display the received order information, logistics information, or the like on an incoming call display interface of the terminal. In some embodiments, the query response can cause the terminal to display the received order information using a function call, interface write, or the like. In some embodiments, the terminal is configured to display the received order information in response to receiving the query response. For example, in response to receiving the query response, the terminal executes code that displays the received order information, logistics information, or the like on an incoming call display interface.

In some embodiments, the order information includes an order number, a picture of an ordered item, the name of the ordered item, the price of the ordered item, an order status of an order, a quantity of the ordered item, an expected delivery date of the ordered item, a name of the person that ordered the item, a date on which the ordered item was ordered, an identifier (e.g., name) of a vendor or service provider, or other such order-related information.

In some embodiments, the logistics information includes a tracking number, the shipping company, the name of the delivery person, the point of origin, or other such logistics-related information.

In some embodiments, at 320, a network device (e.g., the server) uses the user ID included in the query request to look up (e.g., search for) uncompleted order information (e.g., order information without confirmed receipt of product) among the order information corresponding to the user ID. In response to finding uncompleted order information, the network device can return the uncompleted order information in the query response. For example, the network device can return the uncompleted order information in the query response in the event that the calling number or other identifier associated with the incoming call (e.g., the calling number of the caller) corresponds to contact information associated with the order corresponding to the uncompleted order information (e.g., if the contact information matches the shipping company or delivery person).

In some embodiments, the query request includes information identifying the party from which the call originated (e.g., the caller). For example, the query request includes the calling number corresponding to the call request. Accordingly, at 320, the network device determines whether the calling number is present in the first database. If the calling number is present in the first database, the network device uses the user ID to look up (e.g., search for) the order information corresponding to the user ID, logistics information corresponding to the order information, or the like. The first database is used to store telephone numbers for triggering related information queries. For example, the telephone numbers stored in the first database can include the telephone numbers of logistics personnel, various kinds of service providers, or the like. For example, the first database could save the numbers of courier company personnel and/or the telephone numbers of such services as food delivery, airlines, and a telecommunications provider. If, after the network device receives a query request sent by the terminal, it is determined that the calling number is present in the first database, the presence of the calling number in the first database can indicate a need to use the query request as a basis for acquiring related information. In such a case, the network device uses the user ID to look up order information corresponding to the user ID, logistics information corresponding to the order information, or the like. For example, in the event that the network device (e.g., the server) finds a record associated with the calling number in the first database, the network device further queries a second database for particular order information corresponding to the user ID, logistics information corresponding to the order information, or the like. The network device can query the second database for uncompleted order information.

The first database can be periodically updated and periodically maintained to ensure the real-time nature and accuracy of the content. During specific implementation, the network device can acquire logistics personnel contact information from a third party, such as a logistics company, and update the first database. In some embodiments, the network device can update, or otherwise populate, the first database with contact information received from a third party (e.g., a third party that aggregates contact information associated with logistics companies or logistics personnel).

In some embodiments, there are multiple second databases. Thus, the first database stores mappings between telephone numbers and corresponding second databases. The second databases can store mappings between user IDs and order information, logistics information, or the like corresponding to user IDs. The first database can store mappings between telephone numbers and a plurality of other databases (e.g., the second database 140 and the third database 150 of FIG. 1). In some embodiments, the second database includes mappings to one or more telephone numbers. For example, the second databases may include an order database in an e-commerce system (e.g., the Taobao system) and the database of an airline booking system. In such a case, at 320, the network device can query the second database using the calling number associated with the call request. For example, the network device can use the calling number to search the first database for the second database corresponding to the calling number, and subsequently search the second database for the order information corresponding to the user ID, the logistics information corresponding to the order information, or the like.

For example, the first database includes the telephone numbers of logistics personnel and the telephone numbers of airlines, as well as an indication of (e.g., an identifier associated with) the database of an e-commerce system (e.g., the Taobao system) corresponding to telephone numbers of the logistics personnel or the database of an airline corresponding to airline telephone numbers. If, after receiving the query request sent by the terminal, the network device determines that the calling number included in the query request is present in the first database and that the database corresponding to the calling number is an e-commerce system database (e.g., a Taobao system database), the network device sends a query request (e.g., a second query request) to the Taobao system database. The second query request can include the calling number included in the query request received from the terminal. If the database corresponding to the calling number is an airline database, then the network device sends a query request (e.g., the second query request) to the airline system database.

In some embodiments, the first database stores mappings of logistics information to telephone numbers. The logistics information can be tracking numbers (e.g., a tracking number associated with an order or delivery). Accordingly, process 300 can further include querying the first database for a telephone number associated with logistics information. The query of the first database for the telephone number associated with logistics information can be performed between 320 and 330 of FIG. 3. For example, the network device uses the looked-up logistics information to search for the telephone number corresponding to the looked-up logistics information in the first database. In some embodiments, in the event that the looked-up telephone number matches the calling number corresponding to the call request, then at 330, the looked-up logistics information, the order information corresponding to the logistics information, or the like is sent via a query response to the terminal.

For example, a plurality of tracking numbers can be associated with a user. In the event that the network device queries the database using the user ID associated with the user, the query results can return tracking number A and tracking number B as being associated with the user ID. The network can search the first database for telephone numbers corresponding to these two tracking numbers: telephone number 1 corresponding to tracking number A and telephone number 2 corresponding to tracking number B. The calling number can be compared to number 1 and number 2. If number 1 matches the calling number, the order content and other such information corresponding to tracking number A are sent to the terminal via the query response. If number 2 matches the calling number, the order content and other such information corresponding to the tracking number B are sent to the terminal via the query response.

Accordingly, it is possible to send, from all the orders associated with a user, the order information corresponding to the calling number of the call request received by the user and thus to ensure that the information sent to the user is related to the incoming call request.

The order content can be stored in another database. For example, a second database is used to store order numbers and tracking numbers, and a third database is used to store order content, including product-related information in orders. In the event that the order content is stored in a third database, at 320 of FIG. 3, the network device can use the user ID to search the second database for the order number corresponding to the user ID and subsequently use the looked-up order number to search the third database for the order content corresponding to the order number. The second database stores mappings of order numbers corresponding to user IDs, and the third database stores mappings of order numbers and order content corresponding to order numbers. The order content can include names of order items, prices of order items, pictures of order items, quantity of order items, or other such information.

In some embodiments, after a terminal receives a call request, the terminal sends to the network side a query request which includes the user ID corresponding to the terminal. In response to the network side receiving the query request from the terminal, the network side uses the user ID to search for order information corresponding to the user ID, logistics information corresponding to the order information, or the like. In the event that the network side finds order information corresponding to the user ID, logistics information corresponding to the order information, or the like, the network side sends the order information, logistics information, or the like to the terminal via query response. In response to receiving the query response, the terminal can display the received order information, logistics information, or the like on the incoming call display interface. In the event that the terminal receives the call request, the terminal displays the received order information and the logistics information associated with the user ID on the incoming call display interface. For example, the terminal can display the received order information and the logistics information associated with the user ID concurrently with the incoming call request. In some embodiments, the terminal can display the received order information and the logistics information associated with the user ID in connection with a missed call display interface that provides an indication of a missed call associated with the call request. Thus, after receiving the call request (or in connection with receiving the call request), the user can obtain more relevant information, particularly order information or logistics information, and is provided with more comprehensive reference information for determining the user's next operating step (e.g., whether to accept the call, reject the call, or the like).

In a first example of an implementation, a user's mobile phone receives an incoming call from logistics personnel, and the logistics personnel are sending an item purchased by the user on an e-commerce website such as Taobao.

In response to the mobile phone receiving the call request, the mobile phone searches a local database (e.g., a database stored on the mobile phone) for the calling number and determines that the telephone number associated with the call request is an unknown number. In response to determining that the telephone number associated with the call request is an unknown number, the mobile phone sends a query request to the network device such as a server preconfigured to answer such queries.

In response to the network device receiving the query request, the network device searches (e.g., queries) the first database for the calling number. In the event that the calling number is present in the first database (e.g., the first database has a record with the calling number), and the corresponding database associated with the local number is the database corresponding to the e-commerce website (e.g., the Taobao database), the calling number is confirmed as the telephone number of the e-commerce website logistics personnel (e.g., Taobao logistics personnel). In this example, the first database stores a mapping of telephone numbers to corresponding databases (e.g., identifiers of other databases associated with order information or logistics information).

The network device can use the user ID associated with the mobile phone to search (e.g., query) the database corresponding to the e-commerce website (e.g., the Taobao database) for orders corresponding to the user ID. In response to the query of the database corresponding to the e-commerce website (e.g., the Taobao database), the network device receives an indication that order numbers D1 and D2 correspond to the user ID. For example, the network device can receive identifiers respectively associated with order numbers D1 and D2. In response to receiving an indication that the database corresponding to the e-commerce website (e.g., the Taobao database) has records of orders corresponding to the user ID, the network device can search a database (e.g., a third database or the database corresponding to the e-commerce website (e.g., the Taobao database)) for tracking numbers corresponding to the order numbers. For example, the network device can find that the tracking number W1 corresponds to the order number D1 and that the tracking number W2 corresponds to the order number D2. The network device can also search for other information relating to the respective orders corresponding to the user ID. For example, the network device can search the database corresponding to the e-commerce website (e.g., the Taobao database) for the order content, including name and price of the ordered item and other such information corresponding to the user ID for each respective order.

The network device can use the looked-up tracking numbers W1 and W2 to look up the telephone numbers T1 and T2 of the logistics personnel respectively corresponding to the tracking numbers W1 and W2.

The network can compare the telephone numbers of logistics personnel corresponding to orders associated with the user ID to the calling number of the call request. For example, the network device compares the looked-up telephone numbers T1 and T2 of the logistics personnel to the calling number received by the user. If a telephone number of the logistics personnel corresponding to orders associated with the user ID matches the calling number of the call request, the network device can return information relating to the order or logistics of the order to the mobile phone. For example, in the event that the match result is that number T1 and the calling number received by the user are the same, the network device can generate a query response that includes the tracking number W1 corresponding to the telephone number T1, the order number D1 corresponding to the tracking number W1, and the order content corresponding to the order D1. In the event that the network device generates the query response, the network device sends the query response to the mobile phone.

In response to receiving the query response from the server, the mobile phone can extract order information or other such information from the query response. The mobile phone can display the extracted information on an incoming display interface of the mobile phone. For example, the mobile phone extracts the tracking number W1 corresponding to the received telephone number T1, the order number D1 corresponding to the tracking number W1, and the order content corresponding to the order D1 and displays such information on the mobile phone's incoming call display interface.

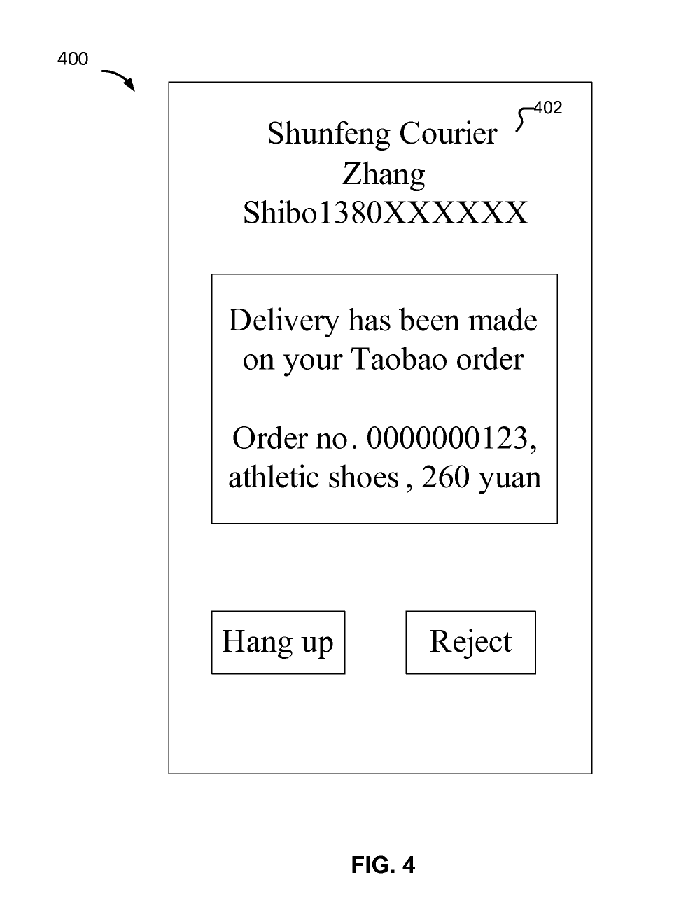

FIG. 4 is a diagram of received information displayed on an incoming call display interface according to various embodiments of the present application.

Referring to FIG. 4, an incoming call display interface 400 is provided. In some embodiments, the incoming call display interface is implemented by system 100 of FIG. 1 or terminal 600 of FIG. 6. The incoming call display interface can be implemented in connection with process 200 of FIG. 2.

The incoming display interface 400 can be displayed on the terminal in connection with an incoming call. For example, the incoming display interface 400 can be displayed concurrently with an incoming call request. The terminal can extract information from a query response received from a server, and can display the extracted information in an area 402 which is overlaid on top of incoming display interface 400. Other placements of the extracted information are possible; for example, the extracted information can be placed in an area that is separate from the incoming display information, or in a separate interface that is displayed in response to a user action such as clicking or scrolling. In the example shown, area 402 includes an identifier or name of a logistics personnel associated with an order, a tracking number, an order number, and the order content. The incoming display interface 400 can receive an input as to whether to accept the call request or reject the call request.

In a second example of an implementation, a user's mobile phone receives an incoming call from an airline.

In response to the mobile phone receiving the call request, the mobile phone searches a local database (e.g., a database stored on the mobile phone) for the calling number and determines that the telephone number associated with the call request is an unknown number. In response to determining that the telephone number associated with the call request is an unknown number, the mobile phone sends a query request to the network device.

In response to the network device receiving the query request, the network device searches (e.g., queries) the first database for the calling number. The network device confirms that the database or service provider corresponding to the calling number is a first airline in connection with the search of the first database.

The network device uses the user ID associated with the mobile phone to search (e.g., query) the services center database for the order information of the airline ticket corresponding to the user ID. The services center database stores transaction data associated with the airline. For example, the transaction data of the first airline is stored in the services center database. The services center database can store a product name, an image associated with a product, an order ID, a logistics ID, a courier's name, a courier's phone number, or the like.

In the event that the network device receives the ticket information of the first airline in connection with the query of the first database for ticket information corresponding to the user ID, the network device sends the ticket information of the first airline corresponding to the looked-up user ID to the mobile phone.

In response to receiving the ticket information of the first airline from the network device, the mobile phone displays the order information of the ticket corresponding to the received user ID on the incoming call display interface of the mobile phone.

FIG. 5 is a structural diagram of a network device according to various embodiments of the present application.

Referring to FIG. 5, a network device 500 is provided. The network device can be a server. In some embodiments, the network device 500 is implemented in system 100 of FIG. 1. The network device 500 can implement process 300 of FIG. 3.

The network device 500 includes a receiving module 510, a querying module 520, and a sending module 530.

The receiving module 510 is configured to receive a query request from a terminal. The query request includes the user ID corresponding to the terminal. The query request is sent by the terminal in response to the terminal receiving a call request. In some embodiments, the query request includes a telephone number of the caller associated with the call request. For example, the query request can include the telephone number of the caller if the terminal does not locally store contact information associated with the telephone number.

The querying module 520 is configured to query a database that stores mappings of information to user IDs. For example, the querying module 520 can use the user ID to search for order information corresponding to the user ID, logistics information corresponding to the order information, or the like.

The sending module 530 is configured to send a query response to the terminal. The query response can include information found in connection with the query request. For example, the sending module 530 can send the order information, the logistics information, transaction information, or other appropriate information, via a query response to the terminal. The terminal displays the received order information, logistics information, transaction information, or other appropriate information on an incoming call display interface of the terminal in response to the terminal receiving the query response.

In some embodiments, the querying module 520 is configured to determine whether the calling number exists in a first database (e.g., whether the first database stores a record associated with the calling number). In the event that the calling number exists in the first database, the querying module 520 can use the user ID search order information corresponding to the user ID, logistics information corresponding to the order information, or the like. The querying module 520 can query the first database for order information corresponding to the user ID, logistics information corresponding to the order information, or the like.

The first database can be configured to store mappings of telephone numbers to related information that can be used to perform additional queries. In some embodiments, the first database stores mappings between telephone numbers and a second database. The second database can store mappings of user IDs and order information, logistics information corresponding to user IDs, or the like. The first database can store mappings between telephone numbers and one or more other databases (e.g., a second database and a third database). The one or more other databases (the second and third databases) can store mappings of telephone numbers associated with one or more service providers, vendors, or the like.

The query module 520 can be further configured to query the second database for information corresponding to the user ID or the like. For example, the query module 520 can use the user ID to search the second database corresponding to the calling number for the order information corresponding to the user ID, logistics information corresponding to the order information, or the like.

In some embodiments, the first database stores mappings between telephone numbers and logistics information.

The sending module 530 can be further configured to send a query response that includes looked-up logistics information and/or the order information corresponding to the logistics information. For example, the sending module 530 (or the querying module 520) can use the looked-up logistics information to look up the telephone number corresponding to the looked-up logistics information in the first database.

In the event that the telephone number of the logistics personnel corresponding to the looked-up logistics information matches the calling number associated with the call request, the sending module 530 can send the looked-up logistics information, the order information corresponding to the logistics information, or the like via a query response to the terminal. In response to the terminal receiving the query response, the terminal can display the received logistics information, order information, or the like on the incoming call display interface.

The querying module 520 can be further configured to search for in the second database an order number corresponding to the user ID. For example, the querying module 520 can use the user ID to look up the order number corresponding to the user ID in the second database.

The querying module 520 can be further configured to search a third database for order content corresponding to the looked-up order number (e.g., retrieved from the second database). For example, the querying module 520 can use the order number (e.g., retrieved from the second database) to look up the order content corresponding to the order number in a third database.

FIG. 6 is a structural diagram of a terminal according to various embodiments of the present application.

Referring to FIG. 6, a terminal 600 is provided. In some embodiments, the terminal 600 is implemented in system 100 of FIG. 1. The terminal 600 can implement process 200 of FIG. 2.

The terminal 600 includes a sending module 610, a receiving module 620, and a displaying module 630.

The sending module 610 can be further configured to send a query request in response to the terminal 600 receiving a call request. The query request can use a user ID associated with the terminal 600. In some embodiments, the query request includes a telephone number corresponding to the call request. The terminal 600 can generate the query request in response to receiving the call request.

The receiving module 620 can be configured to receive a query response from a server such as network device 500 of FIG. 5. The query response can be associated with the query request. The query response can include order information, logistics information, or the like corresponding to the user ID.

The displaying module 630 can display the received order information, logistics information, or the like on an incoming call display interface.

The sending module 610 can be further configured to send the query request in the event that the terminal 600 looks up the calling number corresponding to the call request among the telephone numbers locally stored by the terminal, and the looked up telephone number is marked as a telephone number, or in the event that the terminal 600 fails to look up the calling number corresponding to the call request among the telephone numbers locally stored by the terminal 600.

Various embodiments of the present disclosure provide a method and a device for processing call requests. According to various embodiments of the present disclosure, in response to a terminal receiving a call request, the terminal acquires the user ID associated with the terminal and sends to the network side a query request which includes the user ID. In response to the network side receiving the query request from the terminal, the network side uses the user ID to look up order information corresponding to the user ID, logistics information corresponding to the order information, or the like, and sends the order information, logistics information, or the like to the terminal via a query response. In response to receiving the query response, the terminal can display the received order information, logistics information, or the like on the incoming call display interface. In connection with the terminal receiving the call request, the terminal displays the received order information, logistics information associated with the user ID, or the like on the incoming call display interface. Accordingly, the user of the terminal is informed of relevant information in connection with a call request and is provided with information that the user can use in determining a next operating step.

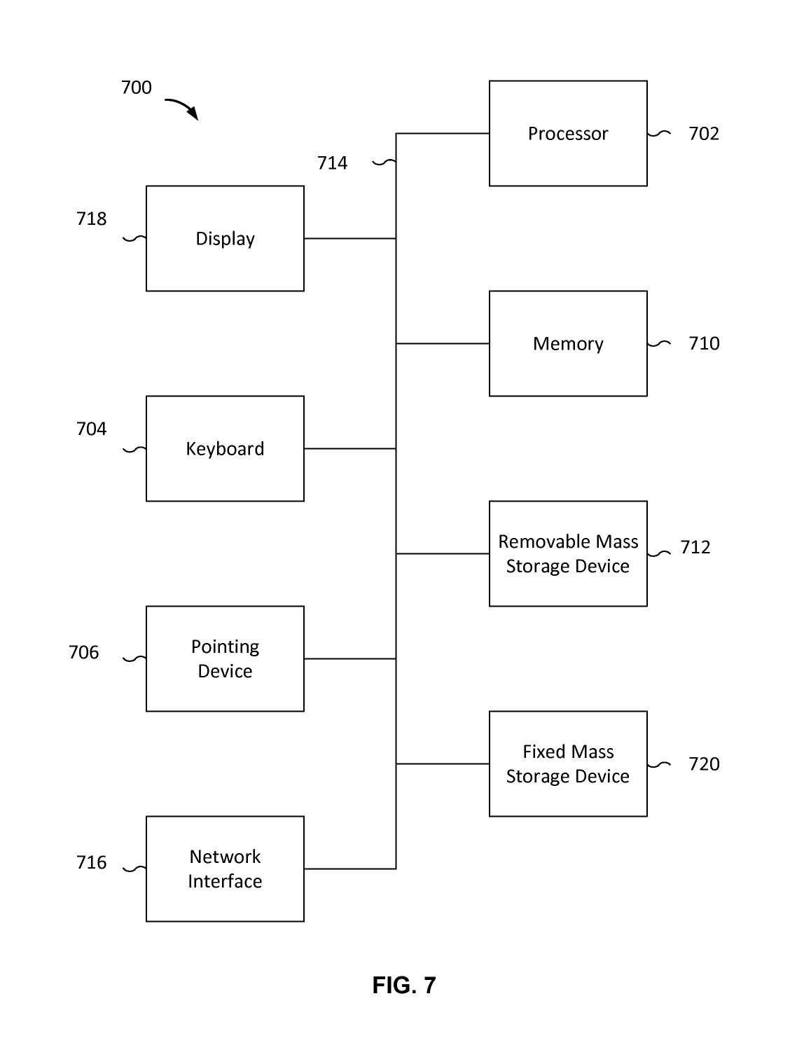

FIG. 7 is a functional diagram of a computer system for processing call requests according to various embodiments of the present application

Referring to FIG. 7, a computer system 700 for processing call requests is provided. As will be apparent, other computer system architectures and configurations can be used to implement video calls. Computer system 700, which includes various subsystems as described below, includes at least one microprocessor subsystem (also referred to as a processor or a central processing unit (CPU)) 702. For example, processor 702 can be implemented by a single-chip processor or by multiple processors. In some embodiments, processor 702 is a general purpose digital processor that controls the operation of the computer system 700. Using instructions retrieved from memory 710, the processor 702 controls the reception and manipulation of input data, and the output and display of data on output devices (e.g., display 718).

Processor 702 is coupled bi-directionally with memory 710, which can include a first primary storage, typically a random access memory (RAM), and a second primary storage area, typically a read-only memory (ROM). As is well known in the art, primary storage can be used as a general storage area and as scratch-pad memory, and can also be used to store input data and processed data. Primary storage can also store programming instructions and data, in the form of data objects and text objects, in addition to other data and instructions for processes operating on processor 702. Also as is well known in the art, primary storage typically includes basic operating instructions, program code, data, and objects used by the processor 702 to perform its functions (e.g., programmed instructions). For example, memory 710 can include any suitable computer-readable storage media, described below, depending on whether, for example, data access needs to be bi-directional or uni-directional. For example, processor 702 can also directly and very rapidly retrieve and store frequently needed data in a cache memory (not shown). The memory can be a non-transitory computer-readable storage medium.

A removable mass storage device 712 provides additional data storage capacity for the computer system 700, and is coupled either bi-directionally (read/write) or uni-directionally (read only) to processor 702. For example, storage 712 can also include computer-readable media such as magnetic tape, flash memory, PC-CARDS, portable mass storage devices, holographic storage devices, and other storage devices. A fixed mass storage 720 can also, for example, provide additional data storage capacity. The most common example of mass storage 720 is a hard disk drive. Mass storage device 712 and fixed mass storage 720 generally store additional programming instructions, data, and the like that typically are not in active use by the processor 702. It will be appreciated that the information retained within mass storage device 712 and fixed mass storage 720 can be incorporated, if needed, in standard fashion as part of memory 710 (e.g., RAM) as virtual memory.

In addition to providing processor 702 access to storage subsystems, bus 714 can also be used to provide access to other subsystems and devices. As shown, these can include a display monitor 718, a network interface 716, a keyboard 704, and a pointing device 706, as well as an auxiliary input/output device interface, a sound card, speakers, and other subsystems as needed. For example, the pointing device 706 can be a mouse, stylus, track ball, or tablet, and is useful for interacting with a graphical user interface.

The network interface 716 allows processor 702 to be coupled to another computer, computer network, or telecommunications network using a network connection as shown. For example, through the network interface 716, the processor 702 can receive information (e.g., data objects or program instructions) from another network or output information to another network in the course of performing method/process steps. Information, often represented as a sequence of instructions to be executed on a processor, can be received from and outputted to another network. An interface card or similar device and appropriate software implemented by (e.g., executed/performed on) processor 702 can be used to connect the computer system 700 to an external network and transfer data according to standard protocols. For example, various process embodiments disclosed herein can be executed on processor 702, or can be performed across a network such as the Internet, intranet networks, or local area networks, in conjunction with a remote processor that shares a portion of the processing. Additional mass storage devices (not shown) can also be connected to processor 702 through network interface 716.

An auxiliary I/O device interface (not shown) can be used in conjunction with computer system 700. The auxiliary I/O device interface can include general and customized interfaces that allow the processor 702 to send and, more typically, receive data from other devices such as microphones, touch-sensitive displays, transducer card readers, tape readers, voice or handwriting recognizers, biometrics readers, cameras, portable mass storage devices, and other computers.

The computer system shown in FIG. 7 is but an example of a computer system suitable for use with the various embodiments disclosed herein. Other computer systems suitable for such use can include additional or fewer subsystems. In addition, bus 714 is illustrative of any interconnection scheme serving to link the subsystems. Other computer architectures having different configurations of subsystems can also be utilized.

The above-stated are merely embodiments of the present application and do not limit the present application. For persons skilled in the art, the present application may have various modifications and variations. Any modification, equivalent substitution, or improvement made in keeping with the spirit and principles of the present application shall be included within the scope of the claims of the present application.

Although the foregoing embodiments have been described in some detail for purposes of clarity of understanding, the invention is not limited to the details provided. There are many alternative ways of implementing the invention. The disclosed embodiments are illustrative and not restrictive.

What is claimed is:

1. A method, comprising:
receiving a query request from a terminal, wherein the query request includes a user identifier (ID) corresponding to the terminal, and is generated in response to receiving a call request at the terminal;
searching for order information, logistics information, or both, corresponding to the user ID;
in the event that the order information, the logistics information, or both corresponding to the user ID is found, generating a query response, wherein the query response includes the order information, logistics information, or both corresponding to the user ID; and
sending the query response to the terminal to cause the order information, logistics information, or both to be displayed on the terminal in connection with the call that is received.

2. The method of claim 1, wherein the searching for the order information, the logistics information, or both corresponding to the user ID is performed concurrently with the call being received at the terminal.

3. The method of claim 1, wherein the order information, the logistics information, or both corresponding to the user ID is displayed on an incoming call display interface of the terminal in response to the terminal receiving the query response.

4. The method of claim 1, wherein the query request includes a calling number corresponding to the receiving of the call; and
wherein searching for the order information, the logistics information, or both corresponding to the user ID comprises:
determining whether a first database stores a record associated with the calling number; and
in the event that the first database stores a record associated with the calling number, searching for order information corresponding to the user ID or logistics information corresponding to the order information.

5. The method of claim 4, wherein the first database stores mappings of telephone numbers to information used in subsequent queries to identify further information related to the receiving of the call.

6. The method of claim 5, wherein the first database is further configured to store mappings between telephone numbers and one or more other databases, wherein one of the one or more other databases is a second database configured to store mappings between user IDs and order information corresponding to user IDs or logistics information; and
wherein searching for the order information, the logistics information, or both corresponding to the user ID comprises:
searching the one or more other databases corresponding to the calling number according to a query of the first database, wherein the searching of the one or more other databases includes searching for order information corresponding to the user ID or logistics information corresponding to the order information, or both.

7. The method of claim 5, wherein the first database stores mappings between logistics is information and telephone numbers;
wherein after searching for the order information, the logistics information, or both corresponding to the user ID, further comprises:
searching the first database for a telephone number corresponding to the logistics information that corresponds to the user ID; and
wherein the generating the query response comprises:
in the event that the telephone number of logistics personnel corresponding to the logistics information that corresponds to the user ID matches the calling number associated with the receiving of the call, including the logistics information or the order information corresponding to the logistics information, or both, in the query response.

8. The method of claim 7, wherein the searching for order information corresponding to the user ID comprises:
searching a second database to locate an order number corresponding to the user ID; and
searching a third database to locate order content corresponding to the order number retrieved in connection with the search of the second database.

9. A method, comprising:
receiving a call request;
in response to receiving the call request, sending a query request to a server, wherein the query request includes a user identifier (ID);
receiving a query response corresponding to the query request, wherein the query response includes order information corresponding to the user ID, logistics information, or both; and
in response to receiving the query response, displaying the order information or the logistics information, or both, included in the query response on an incoming call display interface.

10. The method of claim 9, wherein the order information, the logistics information, or both, included in the query response is displayed on the incoming call display interface concurrently with an incoming call corresponding to the call request.

11. The method of claim 9, wherein the sending the query request comprises:
searching a local database for information corresponding to a calling number corresponding to the call request; and
sending the query request according to results of the search of the local database.

12. The method of claim 9, wherein the sending the query request according to results of the search of the local database comprises:
if the terminal finds the calling number corresponding to the call request among the telephone numbers stored by the terminal and determines to acquire related information in regard to the looked-up number, or if the terminal is unable to find the calling number corresponding to the call request among the telephone numbers stored by the terminal, then the terminal sends the query request.

13. A network device, comprising:
at least one processor configured to:
receive a query request from a terminal, wherein the query request includes a user identifier (ID) corresponding to the terminal, and is generated in response to receiving a call request at the terminal;
search for order information, logistics information, or both corresponding to the user ID;
in the event that the order information, the logistics information, or both corresponding to the user ID is found, generate a query response, wherein the query response includes the order information, logistics information, or both corresponding to the user ID; and
send the query response to the terminal to cause the order information, logistics information, or both to be displayed on the terminal in connection with the call that is received; and
a memory coupled to the at least one processor and configured to provide the at least one processor with instructions.

14. The device of claim 13, wherein the query request includes a calling number corresponding to the receiving of the call; and
wherein the at least one processor is further configured to:
determine whether a first database stores a record associated with the calling number; and
in the event that the first database stores a record associated with the calling number, search for order information corresponding to the user ID or logistics information corresponding to the order information.

15. The method of claim 14, wherein the first database is further configured to store mappings between telephone numbers and one or more other databases, wherein one of the one or more other databases is a second database configured to store mappings between user IDs and order information corresponding to user IDs or logistics information; and
wherein the at least one processor is further configured to search the one or more other databases corresponding to the calling number according to a query of the first database, wherein the search of the one or more other databases includes searching for order information corresponding to the user ID or logistics information corresponding to the order information.

16. The device of claim 14, wherein the first database stores mappings between logistics information and telephone numbers; and
wherein the at least one processor is further configured to:
searching the first database for a telephone number corresponding to looked-up logistics information that corresponds to the user ID; and
in the event that the telephone number of logistics personnel corresponding to the looked-up logistics information matches the calling number associated with the receiving of the call, including the looked-up logistics information or the order information corresponding to the logistics information in the query request.

17. The device of claim 14, wherein the at least one processor is further configured to:
search a second database for an order number corresponding to the user ID; and
search a third database for order content corresponding to the order number retrieved in connection with the search of the second database.

18. A terminal, comprising:
at least one processor configured to:
receive a call request;
in response to receiving the call request, send a query request to a server, wherein the query request includes a user identifier (ID);
receive a query response corresponding to the query request, wherein the query response includes order information corresponding to the user ID or logistics information; and
in response to receiving the query response, display the order information or the logistics information included in the query response on an incoming call display interface; and
a memory coupled to the at least one processor and configured to provide the at least one processor with instructions.

19. The terminal of claim 18, wherein the at least one processor is further configured to:
search a local database for information corresponding to a calling number corresponding to the call request; and
send the query request according to results of the search of the local database.

20. A computer program product, the computer program product being embodied in a non-transitory computer readable storage medium and comprising computer instructions for:
receiving a query request from a terminal, wherein the query request includes a user identifier (ID) corresponding to the terminal, and is generated in response to receiving a call request at the terminal;
searching for order information, logistics information, or both corresponding to the user ID;
in the event that the order information, the logistics information, or both corresponding to the user ID is found, generating a query response, wherein the query response includes the order information, the logistics information, or both corresponding to the user ID; and
sending the query response to the terminal to cause the order information, logistics information, or both to be displayed on the terminal in connection with the call that is received.
